(19) United States
(12) Patent Application Publication
(10) Pub. No.: US 2007/0136572 A1
(43) Pub. Date: Jun. 14, 2007

(54) Encrypting system to protect digital data and method thereof

(76) Inventors: Yen-Fu Chen, Tao-Yuan (TW); Shiuan-Sz Wang, Tao-Yuan (TW); Yi-Chuan Yang, Tao-Yuan (TW); Kuo-Tien Lee, Sanchong City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/417,112

(22) Filed: May 4, 2006

(30) Foreign Application Priority Data
Dec. 14, 2005 (TW) 094144329

(51) Int. Cl. H04L 9/00

(52) U.S. Cl. 713/153

(57) ABSTRACT

An encrypting system to protect digital data and a method thereof are disclosed. During dispatching files to receivers, a compiler is used to add a file key on out-going file to form the first encrypted electronic text and to retrieve file abstract, and then the first encrypted electronic text is encrypted again with a public key to form the second encrypted electronic text which is stored into a database of a server. The file abstract as well as the file key is also encrypted by the public key before being sent to the receivers. The receivers then decrypt the encrypted file by the public key to obtain the original file abstract with which the receivers get the download permission from the server to download the second encrypted electronic text. The receivers then download and decrypt the second encrypted electronic text by the public key into the first encrypted electronic text which is then opened by the compiler by means of the file key to meet the purpose of protecting digital data.

### FIELD OF THE INVENTION

The present invention relates to an encrypting system to protect digital data and a method thereof during the time of dispatching files, especially to an encrypting system and a method thereof for one-to-multiple dispatching to meet the purpose of decreasing transmitting band-width and security control.

### BACKGROUND OF THE INVENTION

The convenient interface and friendly operating environment of internet software makes internet network popular. People gradually get used to rely on sending files via internet which is not only fast dispatch, but also time and cost saving. The e-mails crossing around the network are very easy to be intercepted by some prepared hackers, or some other unsecured servers were at the risk of being intruded. Infringement crime on internet becomes more and more frequently. In order to cope with such kind of infringement, the Digital Rights Management is introduced. The main function of Digital Rights Management is to control the illegal distribution of digital information around the internet, and makes only those authorized receiver get the digital information under the terms and conditions of the digital information author.

The conventional protection method of electronic file and digital data is to generate an encrypted electronic file and a public key of the encrypted electronic file. The encrypted electronic file is sent to the receivers and the public key sent to the server for control purpose, the receiver check out the public key from the server for decrypting the encrypted electronic file. However, there are still some defectiveness on the software of the above mentioned Digital Rights Management to give unauthorized person the opportunity of downloading the encrypted digital data which may decrypt by the continuous effort of the unauthorized person.

In order to solve above problems, U.S. patents such as U.S. Pat. No. 6,289,450 and U.S. Pat. No. 6,339,825 were advocated information security policy to regulate digital data accessing and protect the digital information from pirating. However the above-mentioned encrypting methods still has room to improve. First, ARM software encrypts digital information by using single layer encryption attached with an encrypt key; the file encrypted in this way is opened for any one to intercept and decrypts the encrypted information.

Second, if the encrypted information sent without attaching a decrypt key. The receiver has to get the decrypt key via internet before reading the original information.

As for another encryption method, transmitters send the encrypted information from a server to receivers who then get the decrypt key of the encrypting information from the server. This method is suitable for one-to-one information dispatch, one-to-many information dispatch under this method will cause some technical issues. In current, the prevailing method of transferring digital information is that messenger send encrypted data to the users, this will occupy some band width during file transferring, and increase the opportunity of leaking information to the unfriendly users, therefore a more secure and central control encryption system is needed.

### SUMMARY OF THE INVENTION

It is therefore a primary object of the present invention to provide an encrypting system to protect digital data and a method thereof during the time of dispatching files to the receivers by means of two encrypt keys and central control server over encrypted files to attain the target of double insurance and avoid the opportunity of file decryption during dispatching. Moreover, the present invention will decrease the band width workload by only broadcasting encrypt key with a file to the receivers.

In order to achieve object, the present invention consists of three parts: a transmitter, a server end, and a receiver. The transmitter has a compiler to edit the file whose content is then encrypted using a file key and a public key so as to form two encrypted files for dispatching to the receivers. And the first encrypted file, which includes a second encrypted electronic text that is firstly encrypted with the file key and then encrypted again by the public key, an authorized download list, and a functional permission limitation at receiver's end, is sent to a server. The second encrypted file generated from adding the public key on the file abstract as well as the file key is mailed as an attachment of the e-mail to the receiver. After the first encrypted file is sent to the server on internet, the receiver downloads the second encrypted electronic text in a database of the server according to the authorized download list set by the transmitter.

Moreover, the receiver has a decrypting module to restore the second encrypted file into the file abstract and the file key by means of the public key, then downloads and decrypts the second encrypted electronic text into the first encrypted electronic text before getting the file content by the aid of the file key. A compiler on the receiver uses the file key obtained by decryption to decrypt the first encrypted electronic text so as to open and read the file content.

According to above purpose and advantages, the method of protecting digital data at the transmitter according to the present invention includes following steps:

After a file being edited by the compiler, the file is encrypted with a file key to form the first encrypted electronic text before sending the file to the receiver. At this moment, the transmitter has to verify the file and each of the receivers. After giving the sending instruction, the abstract and the file key retrieved and input by the compiler are encrypted by the public key to form the second encrypted file then being submitted to the receiver. The first encrypted electronic text is encrypted again with the public key to form the second encrypted electronic text. Now check to see if the encryption has been finished. If finished, then organize the second encrypted electronic text, the receiver's download authorization list, and functional permission limitation list of software at receiver's end into the first encrypted file which is then sent to a server on internet for storage in a database.

The methods of protecting digital data at the receiver includes following steps:

Firstly, receive the second encrypted file that is encrypted by the public key and is composed of the file abstract and the file key. Then the compiler decrypts the second encrypted file by the public key so as to get file abstract. The file abstract is used as a permission to download the mapped file of the second encrypted electronic text from the server; whereas the public key is used to decrypt the second encrypted electronic text and also to confirm whether the decryption is finished or not. When it is done, confirm by the compiler that if the previous file key can decrypt the first encrypted electronic text or not. If the answer is yes, decrypt the first encrypted electronic text by the file key into executable and readable text.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1a & FIG. 1b are schematic drawings of embodiments of encrypting systems to protect digital data in accordance with the present invention; FIG. 2a & FIG. 2b are flow charts of a method for protecting digital data in accordance with the present invention.

### DETAILED DESCRIPTION OF THE PREFERRED EMBODIMENT

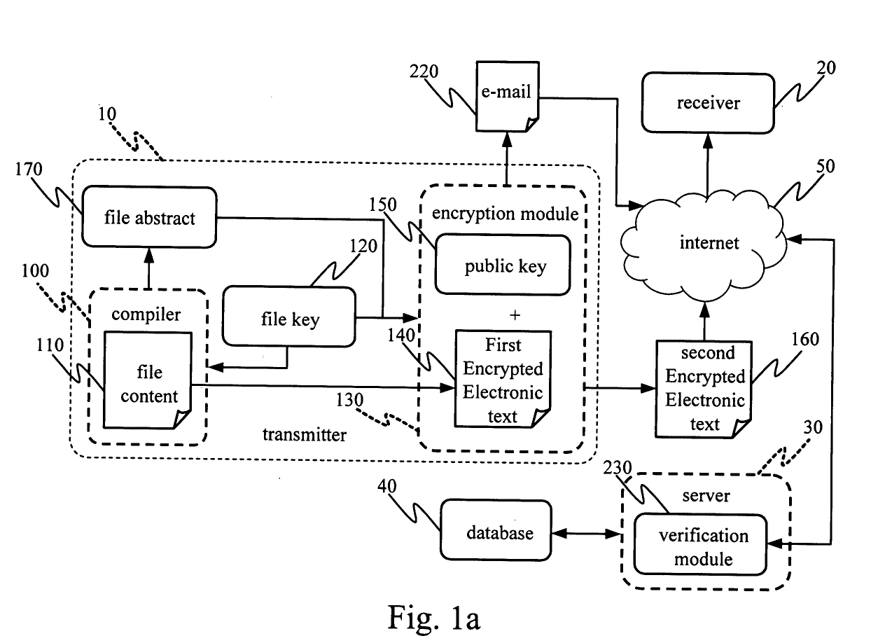

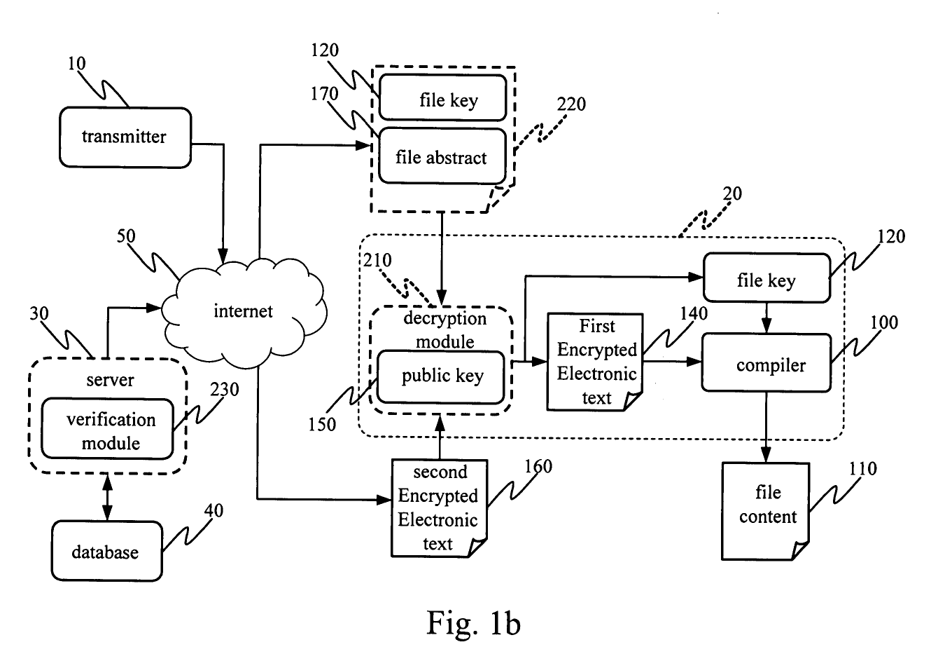

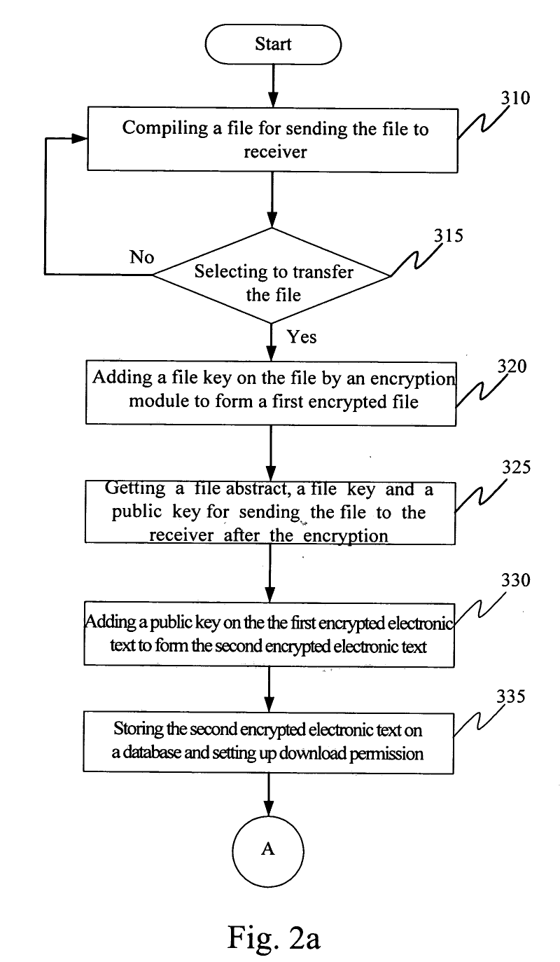

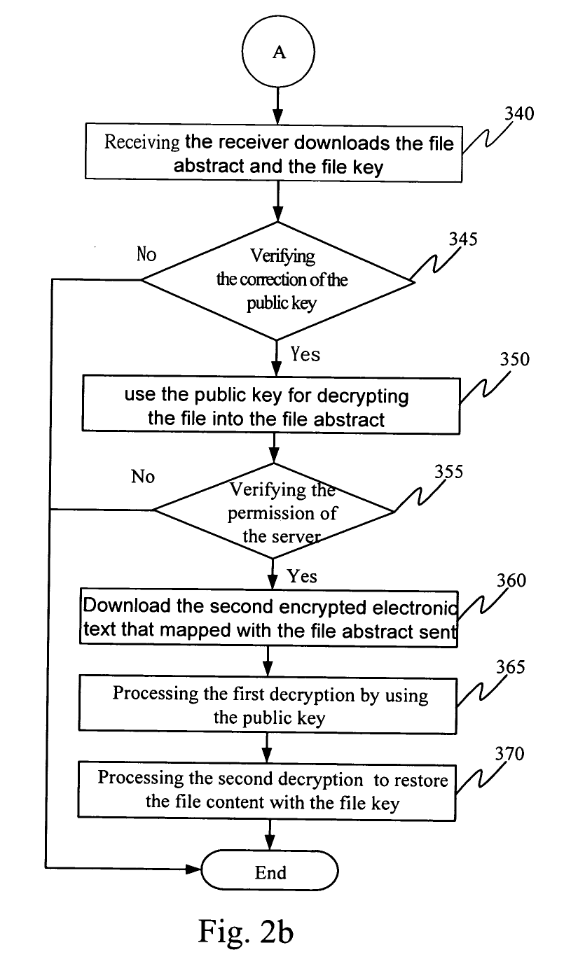

Please refer to FIG. 1a & FIG. 2a, they show the system architecture and flow chart of sending a file 110 from a transmitter 10 to a receiver 20. When users in the transmitter 10 edits a file 110 by a compiler 100, and the file 110 is ready to send to the receiver 20 (step 310), the user selects to transfer the file 110 (step 315), the compiler will add a file key 120 on the file 110 by the encryption logic of AES-256 used by the present invention (step 320). Other symmetric key algorithms such as DES,3-DES,RC5, and IDEA can also be used.

While preparing for transmitting file, the file key 120 and a file abstract 170 having a subject, an abstract, and part of content of the file 110 are added with a public key 150 by an encryption module 130 to form a first encrypted file which is then sent by an upload program of the compiler 100 or as an attachment of the e-mail 220 sent to the receiver 20 via internet 50 (step 325). The public key 150 could be generated according to user or user groups so that different users or groups used the same compiler 100 in a company have no rights to read or write files unauthorized except owning the same public key 150.

During the process of transmitting the file 110 The compiler encrypts the finished file 110 by adding the file key 120 as first encrypting processing to form the first encrypted electronic text 140. Then once more the public key 150 is added on the first encrypted electronic text 140 by the encryption module 130 to form the second encrypted electronic text 160 (step 330). Next together with receiver's 20 download authorization list and receiver's permission limitation list, the second encrypted electronic text 160 is sent to a server 30 on internet 50. Users on the transmitter 10 can set up some control add-ins on the server such as the basic identification of receiver's 20 computer, download log of the second encrypted electronic text 160, and the related interactive comments about the file 110 submitted, all of which are read by users on the transmitter 10 only. A verification module 230 sets up download permission according to the authorized download list (such as name of receivers, e-mail addresses, and ID numbers) built by the transmitter 10, and stores the second encrypted electronic text 160 on a database 40 (step 335). The file key 120 and the public key 150 mentioned above are generated by a set of digital bytes, in the example of the present invention, the cryptographic key is set at 256 bits length for better security consideration.

As for the receiver 20 processing of downloading data from the transmitter 10, please refer to FIG. 1b, show the system architecture of the receivers 20 downloading and decrypting file 110. Also refer to FIG. 2b, it shows a flow chart of the method of downloading and decrypting the file 110. While receiving the e-mail 220 with a downloading notice of the file 110, the receiver 20 downloads the file abstract 170 and the file key 120 attached in the e-mail 220 by means of the public key 150 (step 340). At this stage, also verify whether the attachment of the e-mail 220 can be decrypted by the public key 150 of the receiver 20 or not (step 345).

If the file source and the public key authenticate correct, users use the public key 150 for decrypting the file into the file abstract 170 having subject, abstract, and partial content of the file (step 350), also having a set of the permission for entering into server 30, such as an authorized html page which could link to database server directly, or store the user ID, password, and e-mail address of authorized users of the receiver 20 at a verification module 230 of server 30 for the log-in of the receivers. When users on the receiver 20 log in database server by entering User ID, password, or link with the database server by the authorized html page, the verification module 230 will verify the data entered by the users (step 355) and allow permission to download the second encrypted electronic text 160 that mapped with the file abstract sent by the transmitter 10 after verifying with no error match (step 360).

After finishing downloading, the verification module 230 records some data of the receiver 20 such as log-in time, user ID, IP address, MAC address. Then the decryption module 210 firstly decrypts the downloaded second encrypted electronic text 160 by means of the public key 150 to get the first encrypted electronic text 140 (step 365). Then the compiler 100 is used to decrypt the first encrypted electronic text 140 by means of the previously received file key 150, and restore the file content 110 with limited functions such as right mouse key locked, write protection, copy protection, no print and save, . . . etc according to the permission limitation at receiver 20. The receiver 20 can write down any comments at reply field pop up by the server 30, then the comments are submitted to the server 30. Thus the transmitter 10 links with the server 30 to learn the download status of the files 110 and read comments submitted from the receiver 20.

According to the method of the present invention, the file is protected from being read by other users with different public keys 150 at the same compiler 100 environment when the file is finished and is processed with basic encryption by means of adding the file key 150 while being saved. When dispatch files under the architecture of the present invention, the receiver 20 could only receive the file abstract 170 as well as the file key 120 encrypted by the public key 150 so as to avoid the receiver 20 receives the encrypted file 110 content directly that may be intercepted by hostile users.

Thus the risk of the encrypted file content being decrypted is reduced. The transmitter 10 can make clear the downloading status of the receiver 20 by means of the central control of the server 30 which can also disperse download time of the receiver 20 so as to avoid the internet band-width jam by directly sending file content to each receiver at the same time.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An encrypting system to protect digital data comprising
a transmitter, at least one receiver, and a server, wherein the encrypting system is characterized in that when the transmitter sends a file to each receiver respectively, each receiver only receives a file key as well as a file abstract encrypted by a public key and then downloads the content of the file being encrypted twice from the server; the receiver having a compiler for selecting a file key added on content of the file so as to form a first encrypted electronic text key and also for retrieving the abstract; and
an encryption module that encrypts content of the file once again according to the public key so as to form the second encrypted electronic text and adds the public key on the file key as well as the file abstract for encryption while transmitting the file key as well as the file abstract.

2. The system as claimed in claim 1, wherein the server further having a verification module records authorized download list of the receiver for the second encrypted electronic text being set up by the transmitter.

3. The system as claimed in claim 2, wherein the verification module records log-in time, user ID, IP address, and MAC address of each receiver after finishing downloading.

4. The system as claimed in claim 1, wherein the second encrypted electronic text is saved in a database connected with the server.

5. The system as claimed in claim 1, wherein the receiver having a decryption module that decrypts the second encrypted electronic text into the first encrypted electronic text by means of the public key; and
a compiler that decrypts the first encrypted electronic text into content of the file according to the file key.

6. The system as claimed in claim 5, wherein the compiler restricts functions on content of the file according to a functional permission limitation list of software on the receiver.

7. The system as claimed in claim 1, wherein the file key and the file abstract are transmitted in an e-mail.

8. The system as claimed in claim 1, wherein a transmitter is able to check download records of each receiver from the server.

9. A method for protecting digital data comprising the steps of while sending content of a file from a transmitter:
encrypting content of the file into a first encrypted electronic text by a file key;
retrieving a file abstract from the content of the file while transmitting the file;
encrypting the first encrypted electronic text into a second encrypted electronic text by a public key;
sending the second encrypted electronic text into a server; and
sending the file key as well as file abstract to at least one receiver.

10. The method as claimed in claim 9, wherein when the receiver receives content of the file, the method comprising the steps of:
receiving the file key and the file abstract from the transmitter;
logging in the server for downloading the second encrypted electronic text corresponding to the file abstract;
decrypting the second encrypted electronic text into the first encrypted electronic text by the public key; and
decrypting the first encrypted electronic text into content of the file by the file key.
